(19) United States
(12) Patent Application Publication
(10) Pub. No.: US 2009/0030880 A1
(43) Pub. Date: Jan. 29, 2009

(54) Model-Based Analysis

(76) Inventor: Boris Melamed, Jerusalem (IL)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 11/829,202

(22) Filed: Jul. 27, 2007

(51) Int. Cl. G06F 17/30

(52) U.S. Cl. 707/3; 707/E17.135

(57) ABSTRACT

A system for model analysis, the system including means for accessing a model stored on a computer-readable physical medium, the model having a plurality of classes and associations between the classes, and a model analyzer implemented as computer program embodied on a computer-readable physical medium, the model analyzer configured to query each class in the model that has an association with a class of any instance in a set of source instances, thereby identifying a set of target instances that are associated with any of the source instances.

### FIELD OF THE INVENTION

The present invention relates to model analysis in general, and more particularly to providing data lineage information and impact analyses using models.

### BACKGROUND OF THE INVENTION

The information technology (IT) infrastructure of large enterprises may include vast numbers, amounts, and types of assets, including data, computer hardware and software, and sources and consumers of data, making their management a complex task. Two useful tools for managing IT assets within an enterprise are impact analysis and data lineage analysis. In impact analysis one or more assets of an enterprise's information technology infrastructure are analyzed to determine the impact they have on other assets. This is important where, for example, there is a need to modify, suspend, or decommission an asset, such as during routine system maintenance and system upgrades, as well as for disaster recovery planning. In data lineage analysis an analysis is performed of an enterprise's information technology infrastructure and/or an enterprise's operational logs in order to determine the path that data take from their initial entry into or generation within an enterprise to a specific destination within the enterprise.

In recent years enterprises have sought ways to improve the use and management of their IT assets by employing models, such as metadata models, that provide information about their IT assets and their associations. These models are themselves expressed as data that are typically stored in relational databases. Techniques that employ models in support of impact analysis and data lineage analysis are therefore in demand. However, where an enterprise's many IT assets and associations result in increasingly large models that are stored on multiple distributed databases, and where performing such analyses on such models requires increasing amounts of CPU time and other system resources and involves increasing amounts of network communications overhead, efficient model analysis methods would be advantageous.

### SUMMARY OF THE INVENTION

The present invention provides for improved model-based analysis.

In one aspect of the present invention a system is provided for model analysis, the system including means for accessing a model stored on a computer-readable physical medium, the model having a plurality of classes and associations between the classes, and a model analyzer implemented as computer program embodied on a computer-readable physical medium, the model analyzer configured to query each class in the model that has an association with a class of any instance in a set of source instances, thereby identifying a set of target instances that are associated with any of the source instances.

In another aspect of the present invention a method is provided for model analysis, the method including accessing a model stored on a computer-readable physical medium, the model having a plurality of classes and associations between the classes, and querying each class in the model that has an association with a class of any instance in a set of source instances, thereby identifying a set of target instances that are associated with any of the source instances.

In another aspect of the present invention a computer program is provided embodied on a computer-readable medium, the computer program including a first code segment operative to access a model stored on a computer-readable physical medium, the model having a plurality of classes and associations between the classes, and a second code segment operative to query each class in the model that has an association with a class of any instance in a set of source instances, thereby identifying a set of target instances that are associated with any of the source instances.

### BRIEF DESCRIPTION OF THE DRAWINGS

The present invention will be understood and appreciated more fully from the following detailed description taken in conjunction with the appended drawings in which:

FIG. 1 is a simplified conceptual illustration of system for model analysis, constructed and operative in accordance with an embodiment of the present invention;

FIG. 2 is a simplified flowchart illustration of an exemplary method of operation of the model analyzer of FIG. 1, operative in accordance with an embodiment of the present invention; and

FIG. 3 is a simplified graphical illustration of a set of paths generated from the results of exemplary queries applied to model 100 of FIG. 1.

### DETAILED DESCRIPTION OF THE INVENTION

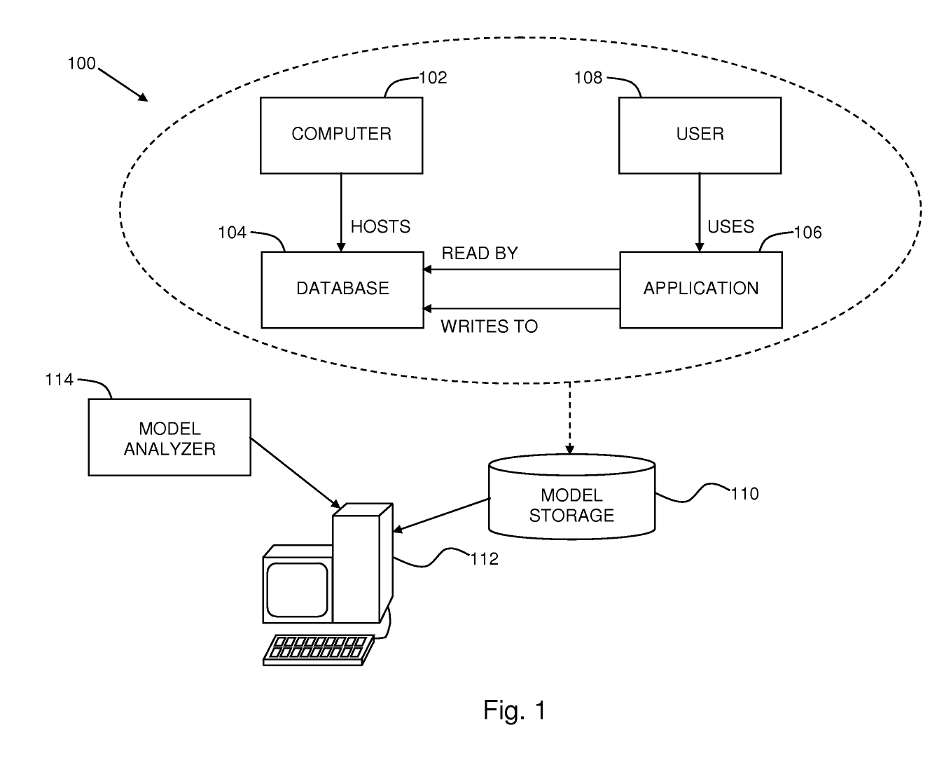

Reference is now made to FIG. 1 which is a simplified conceptual illustration of system for model analysis, constructed and operative in accordance with an embodiment of the present invention. In the system of FIG. 1 an example of a model, generally designated 100 and bounded by dashed lines, is shown. Model 100 may be constructed using any known modeling technology, such as the Unified Modeling Language (UML), that supports classes representing data or metadata, such as of an enterprise IT infrastructure or other system, and the associations between the classes. In the example shown, model 100 includes a computer class 102 which provides metadata about one or more computers, a database class 104 which provides metadata about one or more databases, an application class 106 which provides metadata about one or more applications, and a user class 108 which provides metadata about one or more users. Typically, each class in model 100 collectively represents one or more instances of the class, such as computer 102 representing one or more actual computers. Model 100 also represents the associations between its classes, with each relationship between two classes shown as a solid arrow with an accompanying label. Thus, in the example shown, the relationship between computer 102 and database 104 indicates that computer 102 hosts database 104. Two relationships are shown between application 106 and database 104, one indicating that application 106 reads database 104 and one indicating that application 106 writes to database 104. The relationship between user 108 and application 106 indicates that user 108 uses application 106.

Model 100 is typically stored in a model storage 110, which may be computer memory, magnetic storage, or any other suitable information storage medium. Model 100 may be stored in storage 110 is any suitable format, such as in a relational database (RDB) or object-oriented database (OODB). Model 100 as stored in storage 110 is preferably accessible to one or more computers 112, such as for impact analysis or data lineage analysis as may be performed by a model analyzer 114 whose operation may be controlled by computer 112.

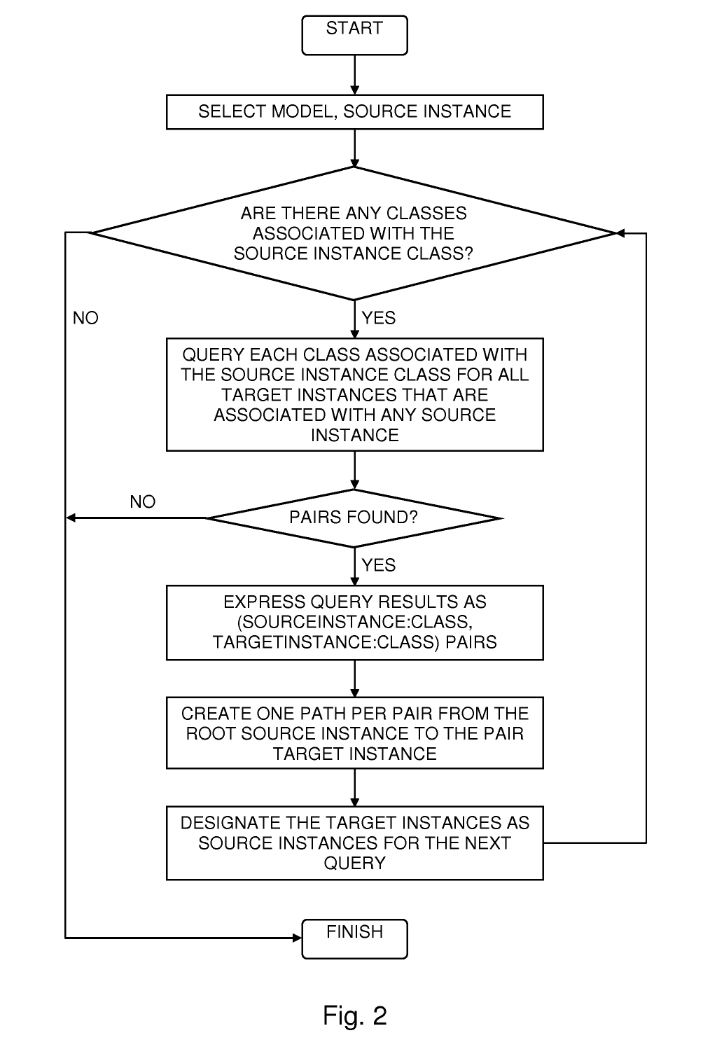

Reference is now made to FIG. 2, which is a simplified flowchart illustration of an exemplary method of operation of the model analyzer of FIG. 1, operative in accordance with an embodiment of the present invention. In the method of FIG. 2 a model is selected for analysis, such as for impact analysis or data lineage analysis. The selected model may be of an entire system or may be selected to only include those classes and their associations that are of interest in the context of the analysis being performed. Thus, in the example shown in FIG. 1, the classes and associations shown in model 100 may be selected to support an impact analysis that, for example, determines the impact that taking a particular computer offline would have on databases that are hosted by the computer, the applications that read from or write to the database, and users of such applications. An instance of a class is also selected as the starting point of the analysis, such as an instance of computer 102 identified as “Bob”. The selected instance populates the set “source instances” for a query in which each class in the selected model that has an association with a class of any instance in “source instances” is queried to identify the set “target instances” that is populated by instances in the queried classes that are associated with instances in “source instances”. This is preferably performed using a single query per association, with the results of the query being one or more pairs in the form (SourceInstance:Class, TargetInstance:Class). Thus, for example, database 104 is queried for each database instance that is hosted by “Bob”, and the results appear as (Bob:Computer, Customers:Database), (Bob:Computer, Orders:Database), etc.

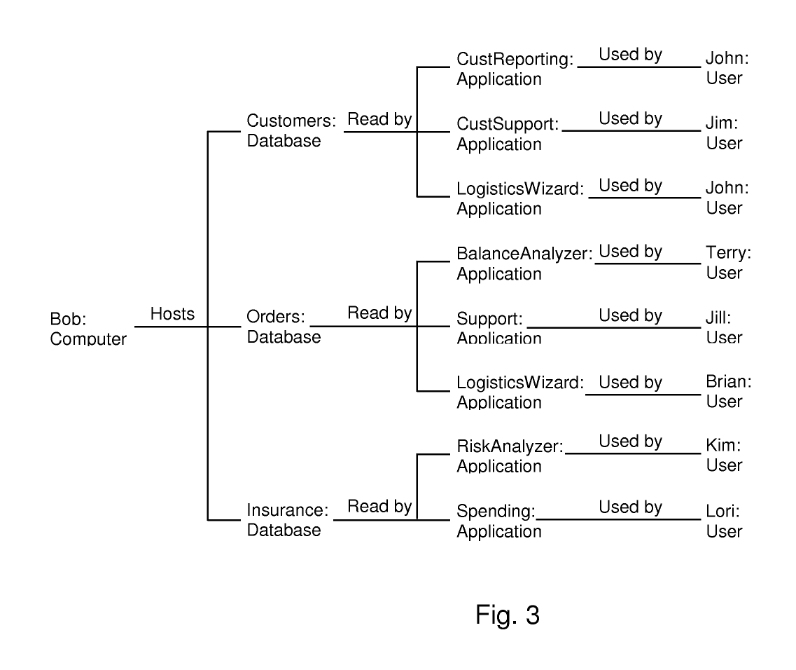

It will be appreciated that each pair resulting from the query represents a path segment of one or more unique paths from the root source instance of the analysis to a target instance of a pair. Representations of any of the paths may be created using any suitable format, such as the graph described hereinbelow with reference to FIG. 3. The next path segment of each path is determined by designating “target instances” as “source instances” for a next query. As before, a query is performed in which each class in the selected model that has an association with a class of any instance in “source instances” is queried to identify the next “target instances” set that is populated by instances in the queried classes that are associated with instances in “source instances”. This is likewise preferably performed using a single query per association, with the results again being expressed as (SourceInstance:Class, TargetInstance:Class) pairs. As before, each pair resulting from the query represents a path segment of one or more unique paths from the root source instance of the analysis to a target instance of a pair resulting from a query, with a target instance in one query becoming a source instance in the next query, and so on, thereby linking path segments from one set of query results to the next. To avoid path loops, a path segment represented by a pair resulting from a query is preferably only linked to an existing path where the target instance of the query does not already exist along the path.

This process of designating “target instances” in one query as “source instances” in the next is preferably repeated until no new path segments are found.

The method of FIG. 2 may be alternatively expressed in pseudo code for use with a UML model as follows:

Given a metadata UML model and an instance (object) of a class:
create an empty map “PendingPaths”: reference->List of Path, where a reference is an association between two classes and is in a list of references which a Path needs to query in order to arrive at the next steps.
create a Path that contains just the start object
for each reference of the start object's class that participates in the analysis type:
   add Path to the list of Paths at this reference, in the PendingPaths map
while the PendingPaths map is not empty:
   use the reference with the most Paths in the PendingPaths map
   fill a new list “SourceIDs” with the IDs of the respectively last object in each Path for the used reference
   submit a query with the SourceIDs list and the used reference, obtain a list of pairs: [SourceID, TargetObject]
   remove the current reference from the PendingPaths map
   for each Path of the used reference:
      for each pair obtained from the query:
         if the last object of Path has the ID “SourceID” of the current pair and it does not already contain TargetObject:
         create a new Path as a continuation of current Path, by adding used reference and the TargetObject of the current pair
         register the new Path with the map PendingPaths
return the result paths.

The pseudo code above assumes that partial paths may be included in the result set, although an alternative implementation might eliminate partial paths from the results.

The query for returning pairs [SourceID, TargetObject] may be expressed as follows:

Input parameters: reference, list of SourceIDs, SourceClass.

The following pseudocode query may be used for returning pairs [SourceID, TargetObject], assuming an ORM (Object/Relational Mapping) layer:
select source.ID, target
from source in SourceClass inner join target in source->reference
where source.ID in [list of SourceIDs]

Where an ORM layer does not exist, the pseudocode may be converted into other query language, such as SQL, provided the reference corresponds to an explicit or implicit Foreign Key.

Reference is now made to FIG. 3, which is a simplified graphical illustration of a set of paths generated from the results of exemplary queries applied to model 100 of FIG. 1. In the example shown, instances of database 100 associated with the source instance Bob:Computer via the “hosts” association are found as a result of a first query, resulting in the pairs

(Bob:Computer, Customers:Database)

(Bob:Computer, Orders:Database)

(Bob:Computer, Insurance:Database).

All instances of application 106 having a “read by” association with any of the instances found as a result of the first query are then found as the result of a second query, resulting in the pairs

(Customers:Database, CustReporting:Application)

(Customers:Database, CustSupport:Application)

(Customers:Database, LogisticsWizard:Application)

(Orders:Database, BalanceAnalyzer:Application)

(Orders:Database, Support:Application)

(Orders:Database, LogisticsWizard:Application)

(Insurance:Database, RiskAnalyzer:Application)

(Insurance:Database, Spending:Application).

Finally, all instances of user 108 having a “uses” association with any of the instances found as a result of the second query are then found as the result of a third query, resulting in the pairs

(CustReporting:Application, John:User)

(CustSupport:Application, Jim:User)

(LogisticsWizard:Application, John:User)

(BalanceAnalyzer:Application, Terry:User)

(Support:Application, Jill:User)

(LogisticsWizard:Application, Brian:User)

(RiskAnalyzer:Application, Kim:User)

(Spending:Application, Lori:User).

It may thus be seen that all paths within model 100 may be identified using just three queries. By contrast, a naïve, prior art approach might apply one query to the root source instance Bob:Computer, one query per database instance found, and one query per application found, resulting in 1+3+8=12 total queries for this example.

For lack of room, FIG. 3 does not address the association “writes to”. However, doing so using the methods of the present invention would result in applying only one more query, for a total of four queries, as opposed to a naïve, prior art approach applying additional queries per database instance found and per additional application instance found.

It is appreciated that the present invention may be applied to any framework of modeled data, and not just to metadata models. For example, the present invention may be applied to an analysis for an on-line music store where, given a customer order for a music album, a list may be produced of all albums by musicians that ever played with any of the musicians on the ordered album. The list may then be used as part of a promotion offering discounts on the albums found during the analysis.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for model analysis, the system comprising:
means for accessing a model stored on a computer-readable physical medium, said model having a plurality of classes and associations between said classes; and
a model analyzer implemented as computer program embodied on a computer-readable physical medium, said model analyzer configured to query each class in said model that has an association with a class of any instance in a set of source instances, thereby identifying a set of target instances that are associated with any of said source instances.

2. The system according to claim 1 wherein said means for accessing a model is configured to access any portion of said model that is of interest in the context of an analysis being performed.

3. The system according to claim 1 wherein said model analyzer is configured to provide the results of said query as one or more pairings of any of said source instances and any of said target instances.

4. The system according to claim 1 wherein said model analyzer is configured to perform said query as a single query per each of said associations.

5. The system according to claim 1 wherein said model analyzer is configured to represent at least one path from a root source instance to any of said target instances.

6. The system according to claim 5 wherein said model analyzer is configured to exclude any of said target instances from any of said paths if said target instance already exists along said path.

7. The system according to claim 1 wherein said model analyzer is configured to perform said query a plurality of times, wherein prior to each performance of said query said set of target instances from an immediately preceding performance of said query is designated as said set of source instances.

8. The system according to claim 7 wherein said model analyzer is configured to perform said query if at least one of said target instances is found as a result of an immediately preceding performance of said query.

9. The system according to claim 1 wherein said model is constructed using the Unified Modeling Language (UML).

10. The system according to claim 1 wherein said classes represent any of data or metadata.

11. A method for model analysis, the method comprising:
accessing a model stored on a computer-readable physical medium, said model having a plurality of classes and associations between said classes; and
querying each class in said model that has an association with a class of any instance in a set of source instances, thereby identifying a set of target instances that are associated with any of said source instances.

12. The method according to claim 11 wherein said accessing step comprises accessing any portion of said model that is of interest in the context of an analysis being performed.

13. The method according to claim 11 and further comprising providing the results of said query as one or more pairings of any of said source instances and any of said target instances.

14. The method according to claim 11 wherein said querying step comprises performing said query as a single query per each of said associations.

15. The method according to claim 11 and further comprising representing at least one path from a root source instance to any of said target instances.

16. The method according to claim 15 and further comprising excluding any of said target instances from any of said paths if said target instance already exists along said path.

17. The method according to claim 11 and further comprising performing said querying step a plurality of times, wherein prior to each performance of said query said set of target instances from an immediately preceding performance of said query is designated as said set of source instances.

18. The method according to claim 17 wherein said querying step comprises performing said query if at least one of said target instances is found as a result of an immediately preceding performance of said query.

19. A computer program embodied on a computer-readable medium, the computer program comprising:
a first code segment operative to access a model stored on a computer-readable physical medium, said model having a plurality of classes and associations between said classes; and
a second code segment operative to query each class in said model that has an association with a class of any instance in a set of source instances, thereby identifying a set of target instances that are associated with any of said source instances.
